(19) United States
(12) Patent Application Publication
(10) Pub. No.: US 2014/0344419 A1
(43) Pub. Date: Nov. 20, 2014

(54) COMPUTER SYSTEM, METHOD OF CONTROLLING NETWORK INTERFACE

(71) Applicant: Yutaka Yoshimura, Tokyo (JP)

(72) Inventor: Yutaka Yoshimura, Tokyo (JP)

(73) Assignee: Hitachi, Ltd.

(21) Appl. No.: 14/117,222

(22) PCT Filed: May 13, 2011
(86) PCT No.: PCT/JP2011/061011

§ 371 Date: Nov. 12, 2013

(51) Int. Cl. H04L 12/24; H04L 29/12

(52) U.S. Cl. CPC H04L 41/08; H04L 61/20
USPC 709/220

(57) ABSTRACT

The purpose of the present invention is to reduce a workload for mapping a physical mounting location of a network interface with the information added to the network interface. A computer system according to the present invention acquires a device address of a network interface recognized by the OS of a computer and identifies the mounting location of the network interface by using a table describing a mapping relationship between the device address of the network interface and the mounting location thereof (see FIG. 1).

### TECHNICAL FIELD

The present invention relates to a technique for managing configuration information network interfaces included in computers.

### BACKGROUND ART

A management controller that is referred to as a BMC (Baseboard Management Controller) is installed in a server computer (hereinafter, a server), purpose of management, a BMC is capable of performing various controls such as for power supplies of servers and the like and of collecting information such as temperature or voltage of the servers. PMI (Intelligent Platform Management Interface) is used as a management interface for BMC to perform various controls for servers and to collect information of the servers.

A BMC is usually supplied with standby power of the server. Thus a BMC is capable of, regardless of the operational state of the OS (Operating System in the server collecting information in the server and of controlling hardware of the server.

In addition, a BMC may remotely control power supplies by utilizing communication function. In order to have a BCM work remotely, it is necessary to set an IP address of the BCM previously. Thus server administrators have to identify the relationship between the BMC and the server.

Conventionally, server administrators manually correlates resource information in the server and registers it using identification information of the BMC for identifying the uniqueness of the BMC (UUID (Universal Unique Identifier) is mainly used) and using identification information for identifying the uniqueness of the server (UUID is mainly used). UUID is an identifier for uniquely identifying servers and is defined by OSF (Open Software Foundation), a standard-setting organization. UUID is stipulated in RFC (Request for Comments) 4122.

Patent Literatures 1 to 3 listed below describe techniques for acquiring information that is set in devices.

Patent Literature 1 describes a technique in which a Ping command is sent to an IP address of a device and a MAC (Media Access Control) address of the device is acquired from the response.

Patent Literature 2 describes a technique for acquiring identification information of an OS from the OS.

Patent Literature 3 describes a technique in which identification information is acquired from a BCM and an OS and the identification information is associated with the same hardware.

### CITATION LIST

### Patent Literature

Patent Literature 1: JP Patent Publication (Kokai) No. 2008-154009 A

Patent Literature 2: JP Patent Publication (Kokai) No. 2007-213271 A

Patent Literature 3: JP Patent Publication (Kokai) No. 2009-135580 A

### SUMMARY OF INVENTION

### Technical Problem

In the above-listed Patent Literatures 1 to 3, even if the technique for acquiring MAC addresses of the server is used, it is necessary to manually associate the MAC addresses with the mounting location of network interfaces.

The mounting location of network interface is a portion of the server where each of the network interfaces is mounted. A plurality of network interfaces may be mounted in a server. In addition, a network interface includes a plurality of types such as one implemented as a PCI (Peripheral Component Interconnect) device and another one mounted on a mother board. Therefore, in order to manage network interfaces, it is necessary to manage the assign state of MAC addresses as well as to manage the relationship between a portion where a network interface is mounted and a MAC address assigned to the network interface. Conventionally, this management task is manually done using spreadsheet software or the like.

Some servers can be equipped with tens of network interfaces in a server. Further, more than one hundred servers may be installed in large-scale data centers. In such cases, the conventional management method for manually associating the mounting locations of network interfaces mounted in the server with the MAC addresses may imposes a huge amount of workload.

As a case where associating the mounting location of network interface with the MAC address is required, an example can be assumed where a plurality of network interfaces is mounted on a server and addresses with different segments are assigned to each of the network interfaces. A network interface configuration of a server by which a hot-standby cluster is constructed may be assumed as a representative example for such cases.

In a case of cluster configuration, in addition to networks used for typical user operations, a plurality of network configurations is required for each of a server, the network including a network dedicated for managing a BMC of the server, a network dedicated for performing a heart-beat between servers of the cluster, and the like.

The present invention has been made to solve the problem stated above, and it is an objective of the present invention to reduce operational burdens for associating physical mounting locations of network interfaces with information assigned to the network interfaces.

### Solution to Problem

The computer system according to the present invention acquires a device address of a network interface identified by an OS of a computer, and identifies a mounting location of the network interface using a table describing a relationship between the device address of the network interface and the mounting location of the network interface.

### Advantageous Effects of Invention

With a computer system according to the present invention, it is possible to identify the mounting location of the network interface by acquiring the device address of the network interface. Since the device address is identified on the computer, it is easy to acquire the information (such as MAC address) assigned to the network interface and to associate the information with the mounting location of the network interface. Namely, it is possible to automatically perform the conventional associating task that was manually performed, thereby reducing the operational burdens of administrators.

### BRIEF DESCRIPTION OF DRAWINGS

FIG. 1 is a configuration diagram of a computer system 1000 according to an embodiment 1 of the present invention.

FIG. 2 is a diagram showing a configuration of a configuration information DB 103.

FIG. 3 is a diagram showing a configuration and a data example of an arp information table 1031.

FIG. 4 is a diagram showing a configuration and a data example of a server information DB 1032.

FIG. 5 is a diagram showing a configuration and a data example of an OS acquisition information DB 1033.

FIG. 6 is a diagram showing a configuration and a data example of a network interface location information DB 1034.

FIG. 7 is a diagram showing a configuration and a data example of a server configuration information DB 1035.

FIG. 8 is a flowchart describing a process for a management module 10 to collect configuration information from a BMC of a target server.

FIG. 9 is a flowchart describing a process for the management module 10 to collect configuration information from an OS of the target server.

FIG. 10 is a flowchart describing a process for the management module 10 to identify a location of a network interface mounted in the target server.

### DESCRIPTION OF EMBODIMENTS

### Embodiment 1: Device Configuration

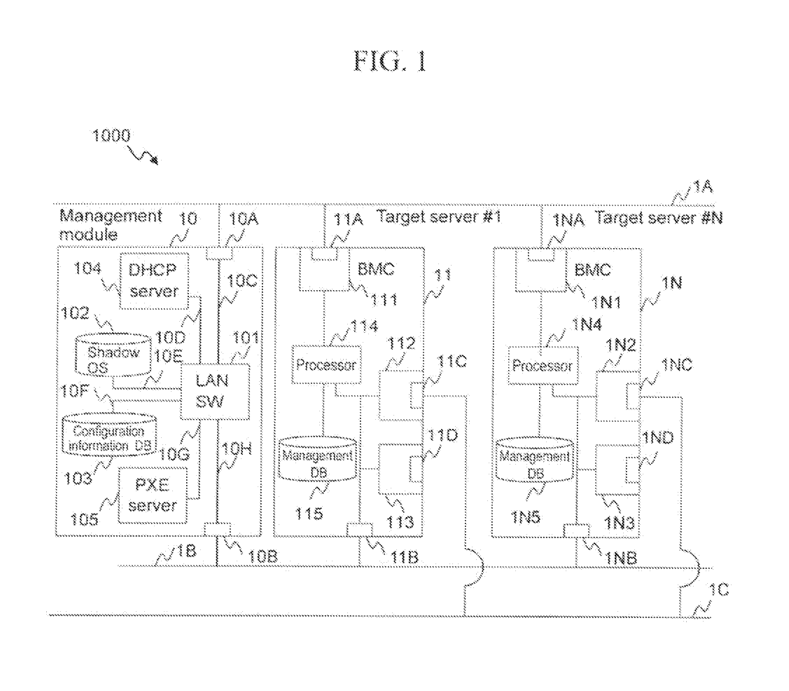

FIG. 1 is a configuration diagram of a computer system 1000 according to an embodiment 1 of the present invention. The computer system 1000 includes a management module 10, a server 11, and a server 1N. These devices are connected to a management network 1A, a information collection network 1B, and an user network 1C.

The management module 10, a BMC 111 in the server 11, and a BMC 1N1 in the server 1N are connected to the management network 1A using network interfaces 10A, 11A, and 1NA respectively.

The management module 10, the server 11, and the server 1N are connected to the information collection network 1B using network interfaces 10B, 11B, and 1NB respectively. The network interfaces 10B, 11B, and 1NB are on-board network interfaces that are mounted as a standard configuration regardless of the server configurations. The information collection network 1B is used only for collecting configuration information of each of the servers.

The server 11 and the server 1N are connected to the user network 1C using network interfaces 11C and 1NC respectively. The network interfaces 11C and 1NC are mounted in network interface cards 112 and 1N2 respectively. The network interfaces 11D and 1ND are mounted in network interface cards 113 and 1N3 respectively.

The management module 10 is a device that manages configurations of network interfaces included in the servers in the computer system 1000. The management module 10 includes the network interfaces 10A and 10B, an internal LANSW 101, a Shadow OS 102, a configuration information database 103, a DHCP (Dynamic Host Configuration Protocol) server 104, and a PXE (Preboot eXecution Environment) server 105. The network interfaces 10A and 10B, the Shadow OS 102, the configuration information DB (Database) 103, the DHCP server 104, and the PXE server 105 are connected to the internal LANSW 101. The internal LANSW 101 is connected to each of the components via routes 10C to 10H respectively.

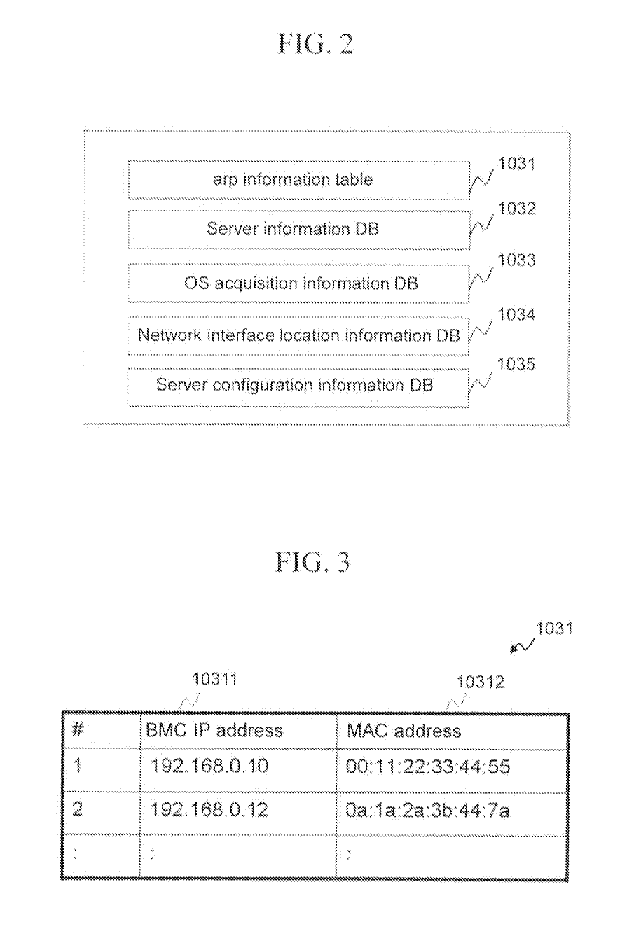

The network interface 10A is connected to the management network 1A and the network interface 10B is connected to the information collection network 1B. The internal LANSW 101 is a network switch that switches the network connections in the management module 10. The Shadow OS 102 is an OS that includes minimum functions required for collecting server configuration information. The configuration information DB 103 will be described using FIG. 2 to FIG. 7 later. IP addresses are distributed to BMCs of each server in the computer system 1000 through the internal LANSW 101. The PXE server 105 is used when each of the servers in the computer system 1000 is booted through network.

“address assign unit” in the present invention corresponds to the DHCP server 104. “network boot OS storage unit” corresponds to the PXE server 105.

Next, the configurations of servers belonging to the computer system 1000 will be described. Since the configurations of each server are the same, the configuration of the server 11 will be described below as an example.

The server 11 includes the network interfaces 11A and 11B, the BMC 111, the network interface cards 112 and 113, a processor 114, and a management DB 115. Each component is connected to each other by wires.

The network interface 11A is connected to the management network 1A and the network interface 11B is connected to the information collection network 1B. The BMC 111 is a management controller that monitors hardware of the server 11 or the like. The BMC 111 is equipped with the network interface 11A. The network interface cards 112 and 113 are connected to the user network 1C. The processor 114 is a processor that controls the overall operation of the server 11. The management DB 115 stores management information including a hardware identifier (described by UUID, for example) of the server 11.

FIG. 2 is a diagram showing a configuration of the configuration information DB 103. The configuration information DB 103 is a database that stores configuration information of each server in the computer system 1000. The configuration information DB 103 stores an arp (address resolution protocol) information table 1031, a server information DB 1032, an OS acquisition information DB 1033, a network interface location information DB 1034, and a server configuration information DB 1035. Details of these tables will be described with FIG. 3 to FIG. 7 later.

FIG. 3 is a diagram showing a configuration and a data example of the arp information table 1031. The arp information table 1031 is a table describing a relationship between IP addresses and MAC addresses of each server. The information held in the arp information table 1031 may be acquired by IP communication between the management module 10 and the BMCs. Details will be described later.

The arp information table 1031 includes a BMC IP address field 10311 and a MAC address field 10312. The BMC IP address field 10311 stores IP addresses of BMCs included in each server. The MAC address field 10312 stores MAC addresses of the BMCs corresponding to the BMC IP address field 10311.

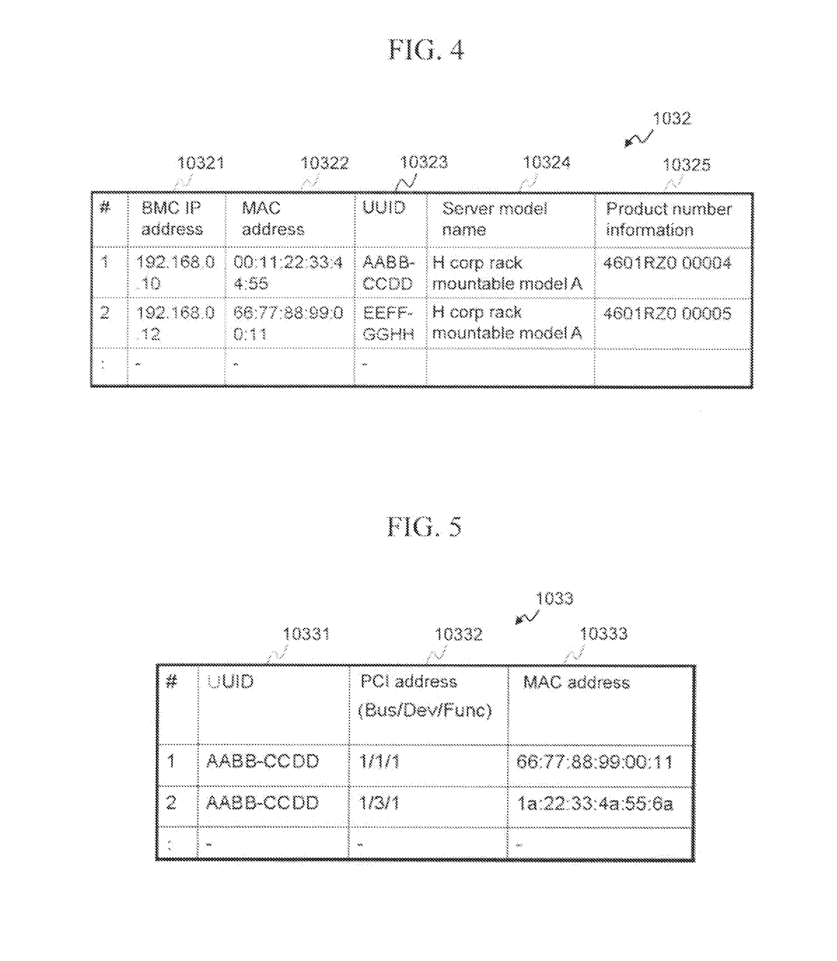

FIG. 4 is a diagram showing a configuration and a data example of the server information DB 1032. The server information DB 1032 is a database that stores configuration information of servers that can be acquired from BMCs included in servers in the computer system 1000, namely configuration information that can be acquired even when OSs of servers are not working.

The server information DB 1032 includes a BMC IP address field 10321, a MAC address field 10322, an UUID field 10323, a server model name field 10324, and a product number information field 10325.

The BMC IP address field 10321 stores IP addresses of BMCs included in each server. The MAC address field 10322 stores MAC addresses of BMCs corresponding to the BMC IP address field 10321. The UUID field 10323 stores hardware identifiers (UUID in this example) of servers that include BMCs corresponding to the BMC IP address field 10321. The server model name field 10324 stores model numbers of servers that include BMCs corresponding to the BMC IP address field 10321. The model number mentioned here is a piece of information by which the relationship with the information stored in the network interface location information DB 1034 can be identified. The model number may not be described in number formats and may be described with server product names or the like. The product number information field 10325 stores manufacture numbers of servers that include BMCs corresponding to the BMC IP address field 10321.

FIG. 5 is a diagram showing a configuration and a data example of the OS acquisition information DB 1033. The OS acquisition information DB 1033 is a database storing configuration information of servers that can be acquired from OSs executed by servers in the computer system 1000. The OSs mentioned here are the Shadow OSs 102 described later.

The OS acquisition information DB 1033 includes an UUID field 10331, a PCI address field 10332, and a MAC address field 10333.

The UUID field 10331 stores hardware identifiers (UUID in this example) of servers. The PCI address field 10332 stores physical device addresses (PCI addresses) of network interfaces identified by OSs of servers specified by the UUID field 10331. The MAC address field 10333 stores MAC addresses assigned to network interfaces specified by the PCI address field 10332.

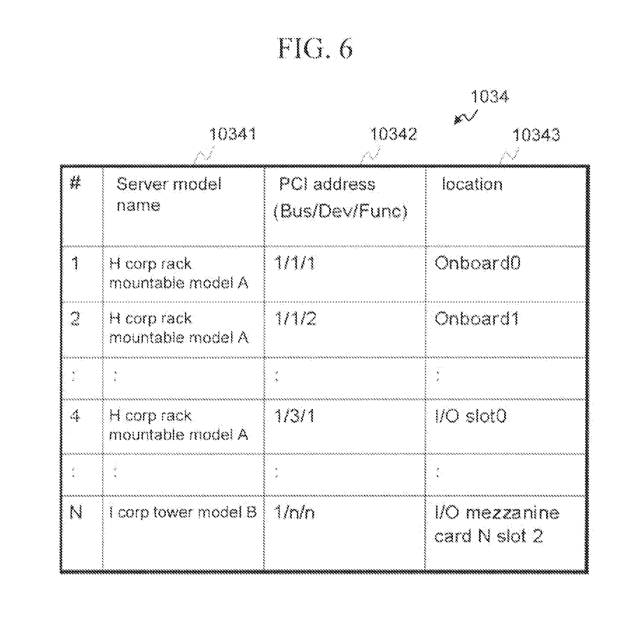

FIG. 6 is a diagram showing a configuration and a data example of the network interface location information DB 1034. The network interface location information DB 1034 is a database describing a relationship between physical locations where network interfaces are mounted in servers and physical device addresses (PCI address in this example) of the network interfaces. The physical locations of the network interfaces and their IP addresses are previously defined for each of model numbers of servers. Thus the computer system 1000 previously sets information stored in the network interface location information DB 1034 for each of the model numbers of servers.

The network interface location information DB 1034 includes a server model name field 10341, a PCI address field 10342, and an intra-server location field 10343.

The server model name field 10341 stores model numbers of servers in he compute system 1000. The PCI address field 10342 stores physical device addresses (PCI address in this example) of network interfaces identified by OSs executed on servers model numbers specified by the server model name field 10341. The cation field 10343 describes locations in servers where devices specified by the PCI address field 10342 are mounted.

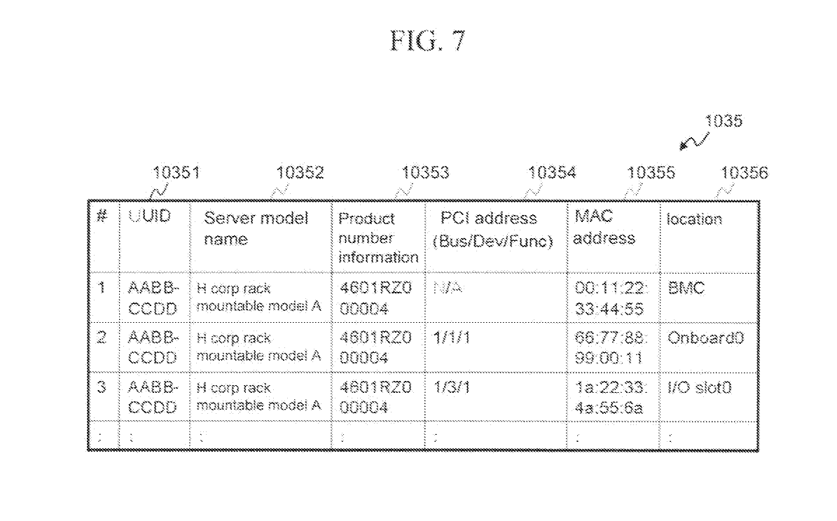

FIG. 7 is a diagram showing a configuration and a data example of the server configuration information DB 1035. The server configuration information DB 1035 is a database storing collected configuration information such as physical mounting locations or MAC addresses of network interfaces included in servers in the computer system 1000.

The server configuration information DB 1035 includes an UUID field 10351, a server model name field 10352, a product number information field 10353, a PCI address field 10354, a MAC address field 10355, and a location field 10356.

The UUID field 10351 stores hardware identifiers (UUID in this example) of servers The server model name field 10352 stores model numbers of servers specified by the UUID field 10351. The product number information field 10353 stores manufacture numbers of servers specified by the UUID field 10351. The PCI address field 10354 stores physical device addresses (PCI address in this example) of network interfaces included in servers specified by the UUID field 10351. The MAC address field 10355 stores MAC addresses of network interfaces specified by the PCI address field 10354. The location field 10356 describes locations in the servers where network interfaces specified by the PCI address field 10354 are mounted.

### Embodiment 1: Overall Operation

The management module 10 acquires configuration information of network interfaces included in servers in the computer system 1000 mainly by three steps. Hereinafter, each of the steps will be outlined.

(Overall Operation: Step 1: Acquiring Information from BMC)

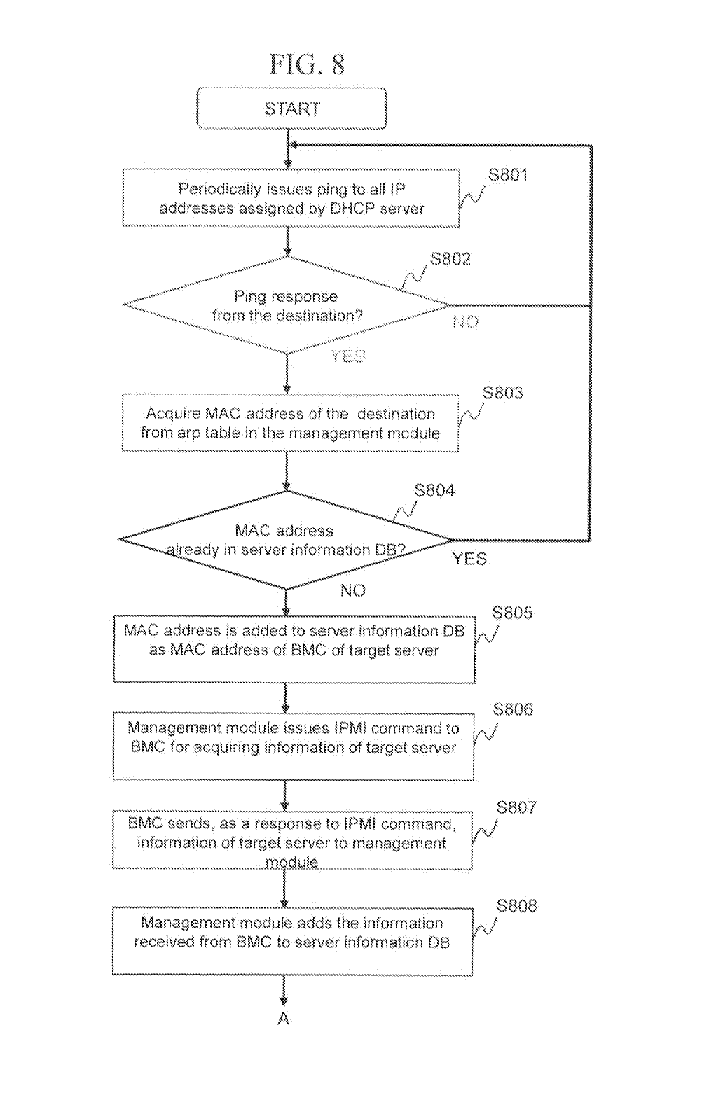

The management module 10 finds BMCs of all target servers in the computer system 1000 by issuing packets requesting a response. The management module 10 registers the IP addresses and the MAC addresses of the BMCs of the target servers into the arp information table 1031. The management module 10 registers the configuration information of the servers acquired from the BMCs into the server information DB 1032. Details of this step will be described with FIG. 8 later.

(Overall Operation: Step 2: Acquiring Information from OS)

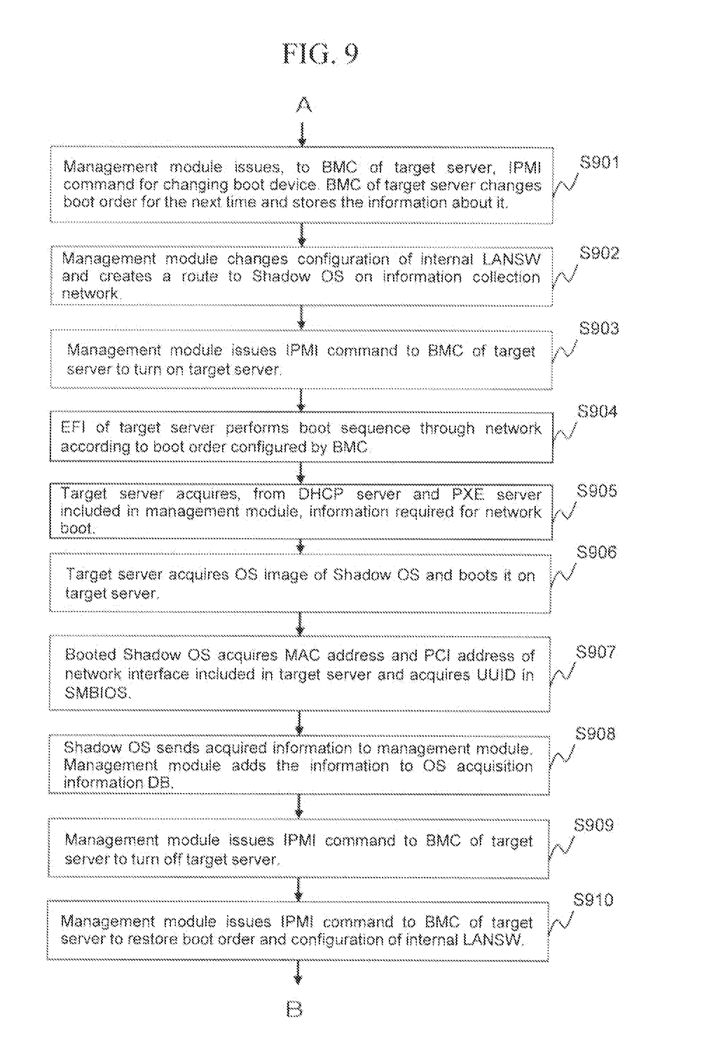

The management module 10 boots the target servers through network. The management module 10 registers, into the OS acquisition information DB 1033, the information collected from the target servers' OSs. The OS mentioned here is the Shadow OS 102 included in the management module 10. Details of this step will be described with FIG. 9 later.

### (Overall Operation: Step 3: Identifying Mounting Location)

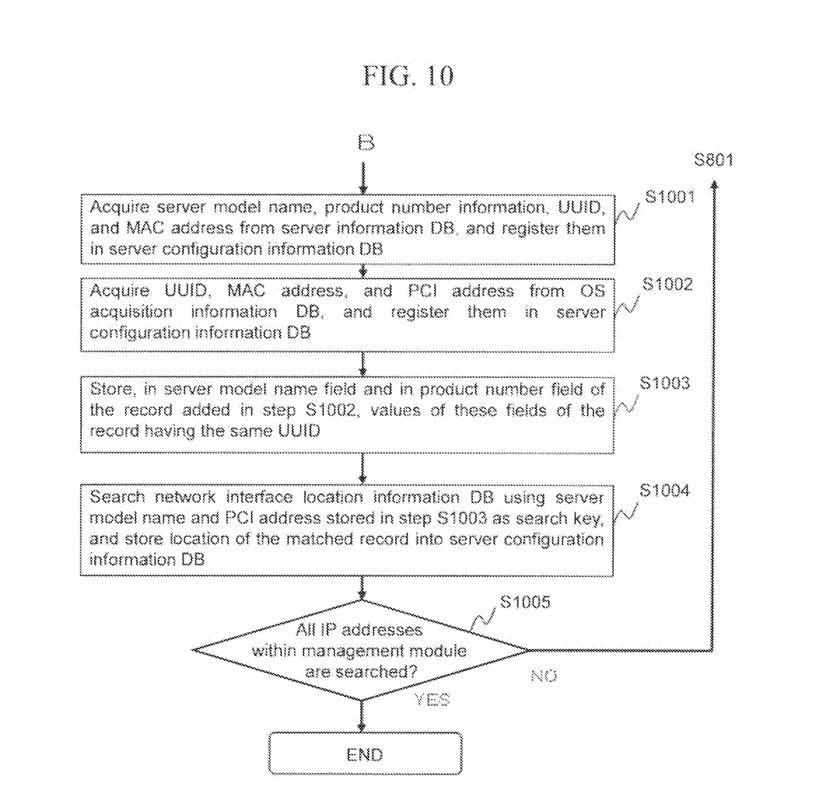

The management module 10 identifies the mounting locations of the network interfaces included in the servers by associating the information acquired from the BMCs and the OSs of the target servers with the information stored in the network interface location information DB 1034. The management module 10 registers the result of the identification into the server configuration information DB 1035. Details of this step will be described with FIG. 10 later.

### Embodiment 1: Detailed Operation

Hereinafter, regarding the operation for acquiring configuration information of the network interfaces included in the servers in the computer system 1000, details of the above-mentioned step 1 to step 3 will be described. It is assumed that the BMCs of each target server are previously configured to utilize the DHCP server 104 in the management module 10 to automatically acquire IP addresses. It is also assumed that each of the BMCs is configured to receive IPMI commands from remote devices.

FIG. 8 is a flowchart describing a process for the management module 10 to collect configuration information from the BMCs of the target servers. Each of steps in FIG. 8 will be described below.

### (FIG. 8: Step S801)

The management module 10 issues ping commands to all IP addresses that are to be assigned with IP addresses by the DHCP server 104 in the management network 1A. A ping command has a role to request a response to the destination address. Using the ping command, it is possible to check whether the destination device is working. Namely, this step has significance in finding BMCs of target servers from which the management module 10 collects information.

### (FIG. 8: Step S802)

If no response is returned from the destination to which the ping command is issued in step S801, the process returns to step S801 and the management module 10 issues a ping command to the next IP address. If a response is returned, the process proceeds to step S802.

### (FIG. 8: Step S803)

The management module 10 registers the IP address and the corresponding MAC address acquired by the response to the ping command into the IP address field 10311 and the MAC address field 10312 of the arp information table 1031, respectively.

### (FIG. 8: Step S803: Additional Note No. 1)

When issuing a ping command, the management module 10 usually issues an arp command before sending the packet to acquire the MAC address corresponding to the destination IP address. Therefore, it is possible to acquire MAC addresses of the destination devices by issuing ping commands.

(FIG. 8: Step S803: Additional note No. 2)

The result of arp command is usually stored in an arp table. The management module 10 may use the arp table instead of the arp information table 1031. Alternatively, the arp information table 1031 may be provided in addition to the arp table. Hereinafter, these tables will not be specifically distinguished.

### (FIG. 8: Step S804)

The management module 10 checks whether the MAC address field 10322 of the server information DB 1032 stores the same MAC address as acquired in step S803. If the same MAC address is stored, the process returns to step S801 and the same process will be performed for the next IP address. If the same MAC address is not stored, the process proceeds to step S805.

### (FIG. 8: Step S805)

The management module 10 creates a new record in the server information DB 1032. The management module 10 registers the IP address and the MAC address acquired in step S803 into the IP address field 10321 and the MAC address field 10322, respectively. According to the above-described process, the server including the BMC that responded to the ping command is registered as a target server. Hereinafter, for the sake of convenience, the server 11 is assumed to be a target server.

### (FIG. 8: Step S806)

The management module 10 issues an IPMI command to the BMC 111 of the server 11 using the value of the IP address field 10321 of the server information DB 1032, thereby requesting the BMC 111 to send, to the management module 10, the information stored in the management DB 115 in the server 11. A hardware identifier (UUID) of the server 11 is stored in the management DB 115.

### (FIG. 8: Steps S807 to S808)

The BMC 111 of the server 11 sends, as a response to the IPMI command, the UUID of the server 11 stored in the management DB 115 (S807). The management module 10 registers the UUID received from the BMC 111 into the UUID field 10323 of the server information DB 1032 (S808).

### (FIG. 8: Step S808: Additional Note)

The management module 10 issues an IPMI command to the BMC 111 using the same sequence as step S808, thereby acquiring the server model name and the product number information of the server 11 from the BMC 111. The management module 10 registers the acquired server model name and product number into the server model name field 10324 and the product number field 10325.

FIG. 9 is a flowchart describing a process for the management module 10 to collect configuration information from OSs of target servers. Each step of FIG. 9 will be described below.

### (FIG. 9: Step S901)

The management module 10 issues an IPMI command to the BMC 111 of the target server 11. The IPMI command requires the server 11 to change the boot order configuration of the server so that the server 11 will boot next time using the PXE server 105. The BMC 111 receives the IPMI command and changes the boot order of the server 11 for the next time as above. The BMC 111 then responds the result of the IPMI command to the management module 10 and stores the boot order configuration. The management module 10 receives the result of the IPMI command from the BMC 111.

### (FIG. 9: Step S902)

The management module 10 changes the communication route configuration of the internal LANSW 101 so that only the route 10D, 10E, 10F, 10G, and 10H can be connected from the network interface 10B. This prepares the step for issuing network boot requests to the target server 11.

### (FIG. 9: Step S903)

The management module 10 sends, to the BMC 111 of the target server 11, an IPMI command that instructs to turn on the target server. The BMC 111 turns on the target server of the server 11 according to the IPMI command. This step is intended to provide a power supply to the processor 114 of the target server 11 to prepare for subsequent steps.

### (FIG. 9: Step S904)

When the power is supplied to the server 11, the processor 114 executes firmwares such as an EFI (Extensible Firmware Interface) to start, according to the boot order configured by the BMC 111, a network boot sequence using the network interface 11B.

### (FIG. 9: Step S905)

The processor 114 requests the DHCP server 104 in the management module 10 to assign an IP address to the network interface 1113. The processor 114 then requests the PXE server 105 in the management module 10 to send an OS image of the Shadow OS 102. This step is for acquiring information required for network boot sequence.

### (FIG. 9: Step S906)

The processor 114 acquires the OS image of the Shadow OS 102 from the PXE server 105. The processor 114 then boots the Shadow OS 102 on the target server 11.

### (FIG. 9: Step S907)

The processor 114 collects, through a driver interface of the Shadow OS, information about MAC address and PCI address of the all network interfaces 11B, 11C, and 11D managed by the OS of the server 11. The processor 114 acquires the UUID of the server 11 from the SMBIOS (System Management BIOS) information of the server 11 that can be acquired by the Shadow OS.

### (FIG. 9: Step S908)

The Shadow OS executed by the processor 114 communicates with the management module 10 through the information collection network 1B, and sends the MAC address, PCI address, and UUID acquired by the Shadow OS to the management module 10. The management module 10 stores the information received from the Shadow OS into the UUID field 10331, the PCI address field 10332, and the MAC address field 10333 of the OS acquisition information DB 1033, respectively.

### (FIG. 9: Step S909)

The management module 10 issues, to the BMC 111 of the target server 11, an IPMI command that instructs to turn off the target server. The BMC 111 turns off the target server of the server 11 according to the IPMI command.

### (FIG. 9: Step S910)

The management module 10 restores the communication route configuration of the internal LANSW 101 to the state before step S902. The management module 10 sends, to the BMC 111 of the target 11, an IPMI command that instructs to restore the boot order to the state before step S901. The BMC 111 restores the boot order of the server 11 to the previous state according to the IPMI command.

According to the above-described sequences, the process for collecting information on the Shadow OS and registering it to the management module is completed.

FIG. 10 is a flowchart describing a process for the management module 10 to identify locations of network interfaces mounted on target servers. Each step of FIG. 10 will be described below.

### (FIG. 10: Step S1001)

The management module 10 stores, among records stored in the server information DB 1032, each of values of the UUID field 10323, the MAC address field 10322, and the product number field 10325 into the UUID field 10351, the MAC address field 10355, and the product number field 10353 of a new record in the server configuration information DB 1035. The management module 10 also stores a value “BMC” in the location field 10356 and a value “N/A” in the PCI address field 10354.

### (FIG. 10: Step S1001: Additional Note)

This step is for storing information that can be acquired from the BMC 111 of the server 11 into the server configuration information DB 1035. This step is also for filling the value of the UUID field 10351 in order to associate it with the information that will be acquired from the same server in the subsequent steps.

### (FIG. 10: Step S1002)

The management module 10 identifies, among records stored in the OS acquisition information DB 1033, a record that has a value of the UUID field 10331 which is the same as that of the UUID field 10351 of the server configuration information DB 1035 stored in step S1001. The management module 10 stores the each of values of the UUID field 10331, the PCI address field 10332, and the MAC address field 10333 of the identified record of the OS acquisition information DB 1033 into the UUID field 10351, the PCI address field 10354, and the MAC address field 10355 of a new record in the server configuration information DB 1035.

### (FIG. 10: Step S1002: Additional Note)

This step is for storing information that can be acquired from the OS of the server 11 into the server configuration information DB 1035. The record having the matched UUID is extracted in order to associate the information that can be acquired from the BMC 111 with the information that can be acquired from the OS. Namely, the BMC 111 acquires server model names and the like and the OS acquires the PCI address, then the UUID can be used for checking whether these values are acquired from the same server.

### (FIG. 10: Step S1003)

The management module 10 stores, in the server model name field 10352 and in the product number information field 10353 of the record that is newly created in step S1002, the values of these fields of the record created in step S 1001.

### (FIG. 10: Steps S1002 to S1003: Additional Note)

If the OS of the target server 11 has already identified a plurality of network interface cards and network interfaces and there are a plurality of MAC addresses and PCI addresses, new records as many as the number of them are created in the server configuration information DB 1035 and values are stored with the same sequence. The values of the UUID field 10351, the server model name field 10352, and the product number information field 10353 are the same.

### (FIG. 10: Step S1004)

The management module 10 searches, using the values of the server model name field 10352 and the PCI address field 10354 of the record stored into the server configuration information DB 1035 in step S1003 as a search key the network interface location information DB 1034. The management module 10 stores, into the location fie d 10356 of the record of the server configuration information DB 1035 stored in step S1003, the value of the location field 10343 of the record acquired by the search.

### (FIG. 10: Step S1004: Additional Note No. 1)

This step is for identifying the mounting location of the network interface using the server model name field 10352 acquired from the BMC 111 and the PCI address field 10354 acquired from the OS as search keys.

### (FIG. 10: Step S1004: Additional Note No. 2)

If the OS of the target server 11 has already identified a plurality of network interfaces, it is necessary to perform this step, as many times as the number of the identified network interfaces.

### (FIG. 10: Step S1005)

The management module 10 checks whether there still is an IP address which information has to be collected. If there still is an IP address which information has to be collected, the process returns to step S801 of FIG. 8 and the same sequences are repeated. If information of all IP addresses has already been collected the process flow terminates.

### Embodiment 1: Summary

As discussed thus far the computer system 1000 according to the embodiment 1 acquires the PCI address of the network interface identified by the OS of the server 11 and searches the network interface location information DB 1034 using the PCI address as a search key, thereby identifying the mounting location of the network interface. This enables automating the task for identifying physical mounting locations of network interfaces that was conventionally performed manually, thereby reducing working burdens of administrators.

In addition, the computer system according to the embodiment 1 combines the information that can be acquired from the BMC 111 included in the server 11 with the information that can be acquired from the OS executed by the server 11, thereby acquiring configuration information that cannot be acquired using those pieces of information alone,

In addition, the computer system according to the embodiment 1 issues ping command to all IP addresses assigned by the DHCP server 104 to find the BMC 111 that is present in the computer system 1000. This eliminates the necessity for checking servers present in the computer system 1000 one by one manually, thereby reducing working burdens of administrators.

In addition the computer system according to the embodiment boots the server through network using the PXE server 105 and collects the information identified by the Shadow OS. This eliminates the necessity for each server o boot he normal OS to collect information and it is only required to boot the Shadow OS that has minimum functions required for collecting information. Therefore, processing loads or processing time for collecting information will be reduced.

### Embodiment 2

In the embodiment 1, an example is described in which it is assumed that the network interface included in the server is implemented as a PCI device and a PCI address is described as the physical device address of the network interface. However, other physical addresses may be used depending on the specification of the network interface.

In the embodiment 1, an example is described in which the relationship between IP addresses and MAC addresses in the computer system 1000 is collected using ping commands. However, it is not necessary to use ping commands and other methods may be used as long as the same result can be acquired.

As described thus far, the invention of the present inventors are specifically described according to the embodiments. However, the present invention is not limited to the embodiments and various modifications are possible as long as without departing from the spirit of the invention.

The configurations, functions, or processing units described thus far may be achieved as hardware by designing all or parts of them using, for example, integrated circuits or may be achieved as software with programs implementing functions of them executed by processors. Information such as programs or tables implementing each function may be stored in storage devices such as memories or hard disks or storage medium such as IC cards or DVDs.

### REFERENCE SIGNS LIST

1A: management network, 1B: information collection network, 1C: user network, 10: management module, 10A to 10 B: network interface, 10C to 10H: route, 101: internal LANSW, 102: Shadow OS, 103: configuration information database, 1031: arp information table, 1032: server information DB, 1033: OS acquisition information DB, 1034: network interface location information DB, 1035: server configuration information DB, 104: DHCP server, 105: PXE server, 11: server, 11A to 11D: network interface, 111: BMC, 112 to 113: network interface card, 114: processor, 115: management DB, 1N: server, 1NA to 1ND: network interface, 1N1: BMC, 1N2 to 1N3: network interface card, 1000: computer system.

1. A computer system, comprising:
one or more computers; and
a management device that manages configuration information of a network interface included in the computer;
wherein
the management device
includes a network interface location information table describing a relationship between a device address of a network interface included in the computer and a mounting location in the computer of the network interface,
acquires, from an OS of the computer, a device address of the network interface identified by the OS of the computer, and
refers to the network interface location information table using the device address acquired from the OS of the computer as a search key, thereby identifying a mounting location of the network interface.

2. The computer system according to claim 1, wherein:
the computer includes a management controller that operates independently from the OS of the computer and that controls a hardware operation of the computer,
the network interface location information table describes, for each of model numbers of the computer, the relationship between a device address of a network interface included in the computer and a mounting location in the computer of the network interface,
the management device acquires a model number of the computer from the management controller, and
the management device refers to the network interface location information table using the model number and the device address acquired from the OS of the computer as a search key, thereby identifying the mounting location of the network interface.

3. The computer system according to claim 2, wherein:
the management controller sends a pair of the model number of the computer and an identifier of the computer to the management device,
the computer sends a pair of the device address of the network interface identified by the OS of the computer and the identifier of the computer, and
the management device associates the identifier of the computer acquired from the management controller with the identifier of the computer acquired from the computer, thereby associating the model number of the computer with the device address.

4. The computer system according to claim 1, wherein:
the management device associates an identifier of the network interface identified by the OS of the computer with a device address of the network interface identified by the OS of the computer, thereby associating the mounting location of the network interface with the identifier of the network interface identified by the OS of the computer.

5. The computer system according to claim 1, wherein:
the computer includes a management controller that operates independently from the OS of the computer and that controls a hardware operation of the computer,
the management device includes an address assign unit that assigns a network address to the management controller, and
the management device issues, to all network addresses assigned by the address assign unit, a request for a response, thereby identifying a presence of all of the one or more computers connected to the management device.

6. The computer system according to claim 1, wherein:
the computer system includes a network boot OS storage unit storing a network boot OS for booting the computer through network,
the computer includes a management controller that operates independently from the OS of the computer and that controls a hardware operation of he computer,
the management device instructs the management controller to boot he computer using the network boot OS,
the management controller boots the computer using the network boot OS according to the instruction from the magement device, and
the management controller sends, to the management device a device address of the network interface identified by the network boot OS.

7. The computer system according to claim 6, wherein:
the management device
includes a network switch that switches a communication route connecting the computer with the network boot OS storage unit,
when instructing the management controller to boot the computer using the network boot OS, switches the communication route so that the computer and the network boot OS storage unit are connected, and
when not instructing the management controller to boot the computer using the network boot OS, switches the communication route so that the computer and the network boot OS storage unit are not connected.

8. A method for managing configuration information of a network interface included in a computer, comprising steps of:
reading a network interface location information table describing a relationship between a device address of a network interface included in the computer and a mounting location in the computer of the network interface,
acquiring, from an OS of the computer, a device address of the network interface identified by the OS of the computer, and
referring to the network interface location information table using the device address acquired from the OS of the computer as a search key, thereby identifying a mounting location of the network interface.
